(19) United States
(12) Patent Application Publication
(10) Pub. No.: US 2019/0311296 A1
(43) Pub. Date: Oct. 10, 2019

(54) Method of Integrating Qubits for Room-Temperature Quantum Computing

(71) Applicants: Haining Fan, Brea, CA (US); Hiroshi Watanabe, Yokohama (JP)

(72) Inventors: Haining Fan, Brea, CA (US); Hiroshi Watanabe, Yokohama (JP)

(21) Appl. No.: 15/984,829

(22) Filed: May 21, 2018

Related U.S. Application Data
(60) Provisional application No. 62/655,645, filed on Apr. 10, 2018.

(51) Int. Cl. G06N 99/00; H04L 9/08; H01L 29/12

(52) U.S. Cl. CPC G06N 99/002; H01L 29/127; H04L 9/0855; H04L 9/0858

(57) ABSTRACT

A method of qubits, a room temperature quantum computing and a system including a controller, a readout, a resistor and a storage are disclosed. The shape and area of each qubits and the pattern of qubit array may be defined by a pattern on a mask simultaneously to control correlations among qubits. The configuration of qubit correlation may be designed three-dimensionally by stacking layers including arrays of qubits. The external generator may be included in another layer stacked with the layers including the arrays of qubits. The qubit may comprise a band structure having a spin-less ground state and a first excited state with spin. The first excited state may not be split for a retention time even under the external field which can influence a spin. The configuration of qubit correlations may be tuned by considering this retention time and an error correction code in quantum computation.

### BACKGROUND OF THE INVENTION

### 1. Field of the Invention

The present disclosure is related to the technology to integrate qubits for room-temperature operating quantum computing.

### 2. Description of the Related Art

It is said that blockchain is so tough to protect data transaction between logical nodes in the network almost completely, as long as the encryption is not broken. It is also said that quantum computer has as 1000 times in ability as the conventional super computer; and then the quantum computer can break today's encryption easily.

Nevertheless, a software engineer may think that if the key length increases by 1000 times blockchain can still go well even in the dynasty of quantum computing. However, this forces all nodes (including personal terminals such as smart phone, tablet, VR, or other new types of personal terminals) to adopt quantum computing chip inside. It is because blockchain assumes peer-to-peer network; which is inconsistent with a network model comprising a central node (server) adopting a quantum computing chip inside and peripheral nodes (client) not having quantum computing chips inside. In peer-to-peer network, any data transaction is validated by a method like a majority decision and then no dominant node is necessary.

If the key length increases by 1000 times, blockchain requires each node to deal with an elongated encryption key in order to maintain the peer-to-peer network. If only a node adopting a quantum computer chip has the ability to deal with the elongated encryption key, this node can behave as a server and then break the concept of peer-to-peer network.

To avoid this, all nodes may be required to adopt quantum computing chip inside in the dynasty of quantum computing.

The quantum computing chip comprises plenty of qubits, each of which permits at least two states to exist simultaneously in a quantum mechanical state at a certain condition (e.g.; states 0 and 1 or states −1, 0, and +1, and so forth). Each qubit corresponds to a bit in the conventional digital processing. However, a bit is either state 0 or 1. In the summation of two qubits, for example, 0+0, 0+1, 1+0, and 1+1 are performed simultaneously, while one of them is performed in two bits.

As the number of qubits increases, the quantum computing chip dominates the conventional digital processing with the same number of bits in the computational ability. However, the retention time of quantum mechanical states of qubits must vary with a certain dispersion. In such a distribution, there may be a qubit having an insufficient retention time which cannot be counted in the computation. Thereby, the quantum computing adopts an error-correction code to prohibit using or recover to some amount lost qubits.

By the way, the retention time at a lower tail may be shortened in the retention time distribution 10, as the number of qubits 11 integrated in a chip increases, as illustrated in FIG. 1. More integrated qubits, therefore, causes more qubits having shorter retention time than shortest one necessary to complete quantum computation 12. This means that the error-correction code excludes more qubits from the computation 13, as the number of integrated qubits. In other words, the retention of the quantum mechanical states limits the increase of qubits integrated in a chip.

Suppose that a quantum mechanical state like this can exist at a very low temperature. The rise of temperature, accordingly, may degrade the retention time. Therefore, a cooling system is absolutely necessary to maintain temperature at which a quantum computing chip operates for a sufficient duration.

However, a cooling system is too large for us to carry a device adopting a quantum computing chip inside, as well as an optical readout system that may been also adopted in a quantum computer. Therefore, only large facilities can use quantum computers and then breaks the assumption that blockchain can protect data transaction between logical nodes in peer-to-peer network.

Can no end users use blockchain in the dynasty of quantum computing? In order to recover the benefit of blockchain, a quantum computing chip which is able to operate at room temperature must be strongly demanded sooner or later.

Nevertheless, there is no validated method to realize a qubit at room temperature at present. However, in recent years, some achievements have been reported to imply the possibility of room temperature qubit (See S. Choi et al., Nature 21426).

Time crystal is a scientific hot topic since F. Wilczek suggested a spontaneous breaking of time-translation symmetry in a closed quantum mechanical system (See F. Wilczek, Physical Review Letters 109, 160401, 2012). N. Yao and his colleagues found a discrete time crystalline (DTC) phase in a quantum system comprising 10 yttrium ions under an external field at very low temperature (See N. Y. Yao, et al., Physical review letters 118, 030401, 2017 and J. Zhang, et al., Nature 543, 217, 2017). S. Choi and his colleagues also found a discrete time crystalline phase comprising nitrogen-vacancy centers (NV-centers) incorporated into a diamond crystal with concentration being 45 ppm at room temperature.

A NV-center behaves as a particle having spin-1 and charge -q, where q is the elementary charge. The average distance between two NV-centers is 5 nm in a diamond crystal. It may be indeed regarded that two NV-centers correlating quantum mechanically each other can form an entanglement state; which is necessary to perform the quantum computing of two qubits. However, we should note that the spatial distribution of NV-centers in a crystal is out of manufacturing control. This may make it difficult to control the quantum computation.

### SUMMARY OF THE INVENTION

The present disclosure is invented in the view of the circumstances mentioned above and then aims at providing an integration method of time-crystalline qubits for room temperature operating quantum computing.

Note that some kind of imperfections in a crystal (like an NV-center) can form a quantum mechanical state which may cause the discrete time crystalline phase. However, for the manufacturing controllability, such a quantum mechanical state should be macroscopic (a commensurate state). As mentioned above, we should also note that each NV-center cannot be a qubit and a qubit should be a commensurate state which may occur in a crystalline, polycrystalline, or amorphous.

Therefore, we may or should form manufacturable qubits. For example, provided that a substrate is covered by a mask which has plenty of windows to leave qubits there. Even though the number of windows in mask is two, it is not limited only two in the present disclosure. The number of windows can be more than two in a mask covering a surface of substrate in the present disclosure. Thereby, the present disclosure may include an array of qubits which may be defined by a pattern on the mask. The shape and area of each qubit and the pattern of array of qubits may be defined simultaneously by a pattern on the mask. And, this substrate may be thinned to be a layer including an array of qubits.

Through this mask, we can incorporate atoms, molecules or ions to the substrate surface. Note that location and number of incorporation areas (or windows in mask) are controllable in the manufacturing.

After removing the mask, we can get plenty of qubits on the surface of substrate. As an example, those qubits correspond to states |A>16a and |B>16b (in FIG. 2), respectively. In general, we can obtain more qubits such as |A>, |B>, |C> . . . according to designed layout of windows in the mask.

If Nitrogen atoms are incorporated into a surface of diamond crystalline as an example, those qubits may be able to respectively comprise populations of NV-centers.

The substrate may be a crystalline of resistivity-controllable materials: such as diamond, silicon, other semiconductors, some kind of compounds, and so forth. The substrate may be polycrystalline or amorphous of resistivity-controllable materials: such as semiconductor, insulator, dielectrics, compounds, and so forth. Note that the resistivity control or controlled resistivity is absolutely necessary to set forth electronic readout on a surface of the substrate.

Imperfections made by this way or made otherwise in a substrate or on a surface of a substrate may have a spin freedom like NV-center (having spin-1) or Yttrium ion (having spin-1/2).

Those imperfections may be incorporated to gather in an area on a surface of a substrate; which area may form a qubit. The number of the imperfections incorporated there may be large enough to make quantum mechanical state related to this qubit macroscopic (or commensurate). Other imperfections made in a similar way may be incorporated to gather in another area on the surface of the substrate; which area may form another qubit. In a similar way, we can make more qubits on the surface of the substrate.

Those qubits may be able to be layout according to a designed pattern, for example a checker-board pattern layout of qubits in the array of qubits. This array may be a part of a room-temperature operating quantum computer chip (RTQC).

In the present disclosure, each qubit is macroscopic (or commensurate) and thus quite different from the prior arts (an Yttrium ion, an NV-center and so on).

Let us propose a macroscopic quantum mechanical state to form a qubit in the present disclosure, wherein we may have a qubit Hamiltonian made of an ensemble of imperfections: H=H₀. There may be a ground state where total spin is zero, that is, spinless. Also, there may be a first excited state where total spin is ½, 1, or more. Anyway, we note that the first excited state may not be spin-less, or note that the first excited state may have spin or spin freedom.

We may note that the energy discrepancy between the first excited state and the ground state may be about thermal energy (1.5 k_{B}T, where k_{B} is the Boltzmann constant and T is the absolute temperature) or less, or more little bit. There may be no states having spin freedom between these states.

At room temperature, therefore, the first excited state can exhibits his characteristic macroscopically. Note that the ground state may not exhibit a magnetic property to be involved in a macroscopic characteristic, as long as the macroscopic quantum mechanical state is formed by spin freedom.

Also, we may apply an external field (Hₑₓₜ) to a qubit (H=H₀+Hₑₓₜ). As long as this external field includes a magnetic field, the spin freedom of the first excited state may reflect to the external field. Or, we may say that the external field potentially influence the spin of the first excited state. Then, the first excited state may split. In this example, the first excited state splits to three states but the number of splits is not limited to only three. It may be two, four, five, or more. The external field may be a magnetic field, an electric field, or an electro-magnetic field. It may be preferable that the external field may be electrically controllable.

However, if a discrete time-crystalline phase transition occurs, this split under an external field may not appear for some duration. We may regard that the first excited state may hardly exhibit a change in split, be unchangeable, or hardly changeable for a retention time even under an external field. This duration may be retention time of macroscopic quantum mechanical state of qubit. This macroscopic quantum mechanical state may or may not be commensurate.

In other words, we may adopt, to a qubit in the present disclosure, a crystalline, a polycrystalline or an amorphous of a substrate material, in order to form a first excited state having spin freedom above a ground state having no spin freedom by thermal energy in band diagram. Also, even under an external field, the first excited state may keep a state with no split for a retention time of qubit.

We may note there is no state having spin freedom in the gap between the first excited state and the ground state. If there is a state having spin freedom in the gap (in-gap state), the spin of this in-gap state may influence the macroscopic characteristic to hide the property of discrete time-crystalline. This may give rise to a noise and then shorten the retention time of qubit or break a qubit.

The qubit A having spin-1/2 in the first excited state is written as:

|A)=α_{A}_{^{|0>}}+β_{A}_{^{|1>}}.

The qubit B having spin-1/2 in the first excited state is written as:

|B)=α_{B}_{^{|0>}}+β_{B}_{^{|1>}}.

The entanglement state formed by the qubits A and B is:

|AB)=α_{|00})+β|0₁)+γ_{|10})+δ|1₁).

In the summation of these two qubits, we may select a state of |00>, |01>, |10>, and |11>. However, if |00> is selected, the result of the summation may be 0. If |10> or |01> is selected, the result may be 1. And if |11> is selected, the result may be 2. We may complete the computation (select one among those states) during the retention time of the qubits.

If the first excited states of two qubits have spin-1 (Sz=−, 0, or +), respectively, the entanglement state formed by these two qubits is:

α_{|00})+β|0+)+γ_{|+0})+δ|++)_{+ε}_{_{|}}_{--)+ζ}_{_{|−+>}}₊_{_{|+−)}}_{+η|}_{₀}_{->+θ|-}_{₀}_{>}.

If the first excited states of two qubits have spin-1/2 (Sz=+ or −) and spin-1 (Sz=−, 0, or +), the entanglement state formed by these two qubits is: γ_{|+0})+δ|++)_{+ε}_{_{|}}_{--)+ζ}_{_{|−+>}}₊_{_{|+−}}_{)+θ}_{_{|−0>}}.

Like this, as the spin freedom of a qubit is decreased, the number of states composing an entanglement state may be decreased.

We may make an entanglement state from two qubits, one of which may have spin-3/2, spin-2, spin-5/2, spin-3 or more. If the spin freedom of a qubit is increased, the number of states composing an entanglement state may be increased.

### BRIEF DESCRIPTION OF THE DRAWINGS

The present disclosure will become more fully understood from the detailed description given hereinafter and the accompanying drawings which are given by way of illustration only, and thus are not limitative of the present disclosure, and wherein:

FIG. 1 illustrates the relation of lower tail of retention time of quantum mechanical states and the number of integrated qubits.

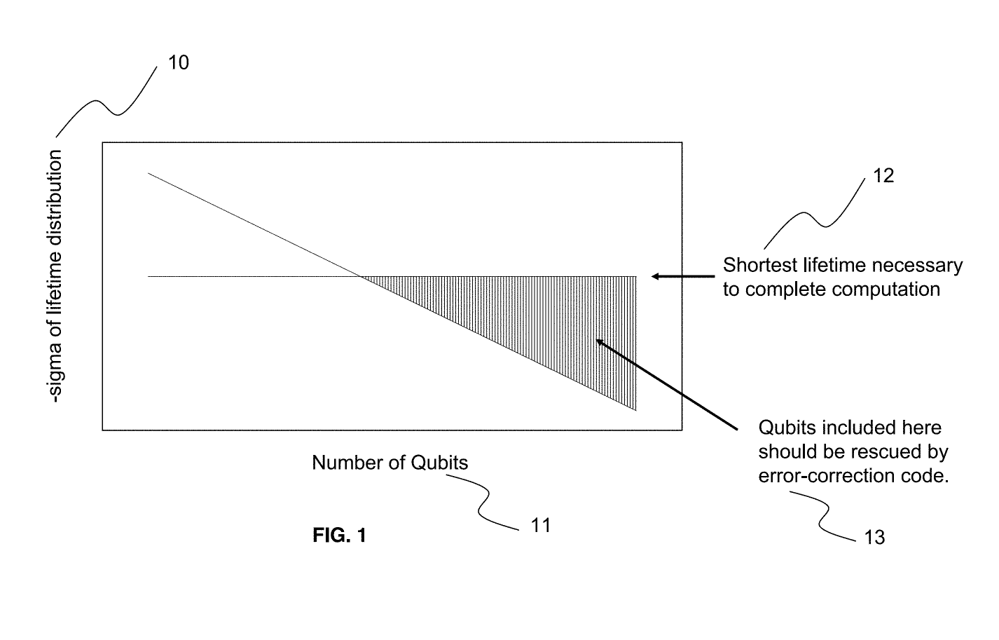

FIG. 2 illustrates an exemplary method to fabricate qubits on a surface of substrate.

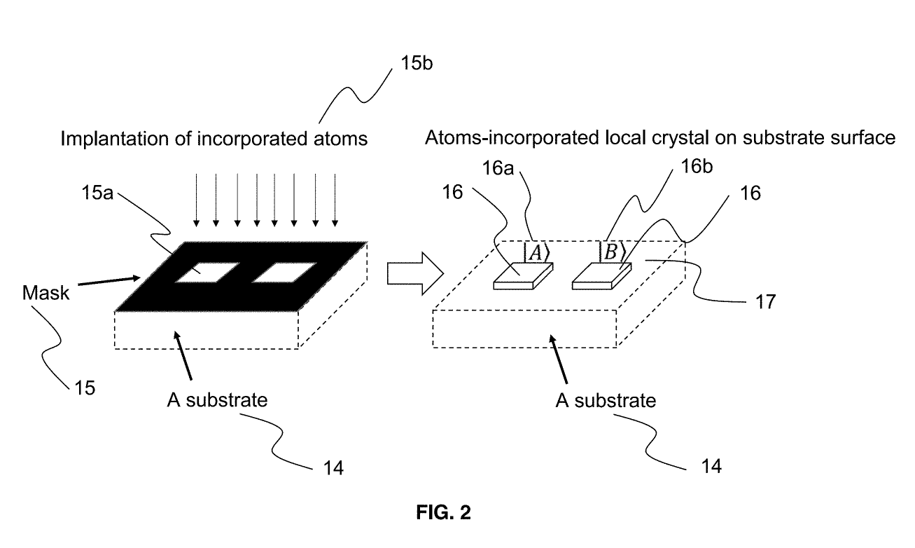

FIG. 3 illustrates an exemplary configuration of array of qubits on a chip of quantum computing at room temperature.

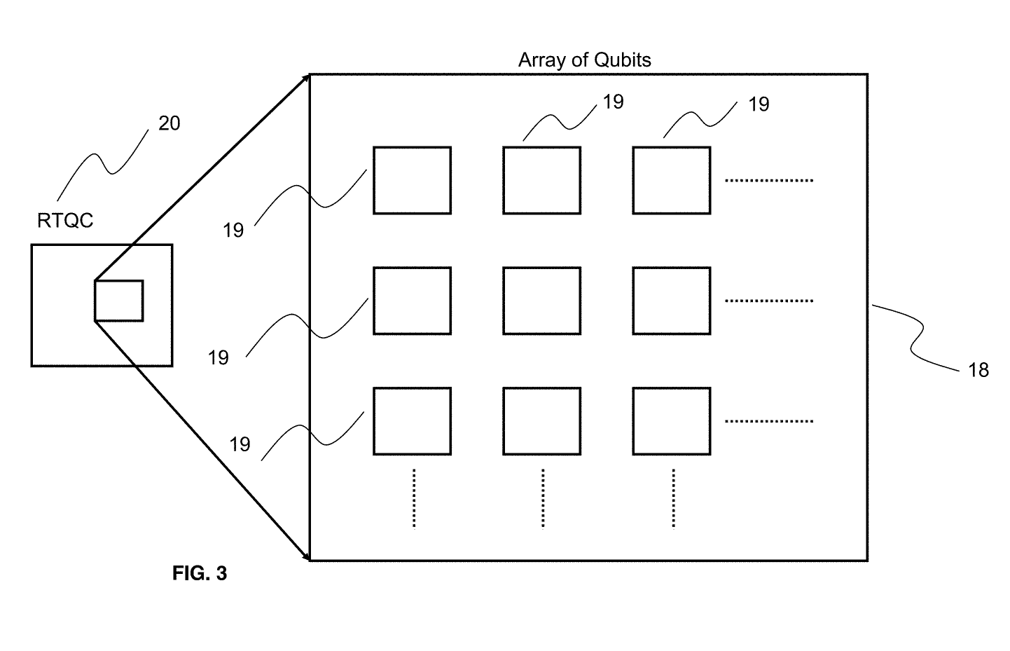

FIG. 4 illustrates an exemplary band structure of discrete time-crystalline material of the present disclosure.

FIG. 5 illustrates an exemplary configuration of quantum computing system operating at room temperature.

FIG. 6 illustrates an exemplary configuration of array of qubits on a chip of quantum computing at room temperature.

FIG. 7 illustrates an exemplary configuration of array of qubits on a chip of quantum computing at room temperature.

FIG. 8 illustrates an exemplary configuration of array of qubits on a chip of quantum computing at room temperature.

FIG. 9 illustrates an exemplary configuration of array of qubits on a chip of quantum computing at room temperature.

FIG. 10 illustrates an exemplary stacking layer structure of quantum computing chip which can operate at room temperature.

FIG. 11 illustrates an exemplary configuration of room temperature operating quantum computing chip.

FIG. 12 illustrates an exemplary configuration of room temperature operating quantum computing chip.

FIG. 13 illustrates an exemplary top view of a layer of room temperature operating quantum computing chip.

FIG. 14 illustrates an exemplary top view of a layer of magnetic field generator.

FIG. 15 illustrates an exemplary top view of a layer of magnetic field generator.

FIG. 16 illustrates an exemplary top view of a layer of electric field generator.

FIG. 17 illustrates an exemplary top view of a layer of electric field generator.

FIG. 18 illustrates an exemplary top view of a layer of EM field generator.

FIG. 19 illustrates an exemplary top view of a layer of EM field generator.

FIG. 20 illustrates an exemplary configuration of room temperature operating quantum computing chip.

FIG. 21 illustrates an exemplary configuration of room temperature operating quantum computing chip.

FIG. 22 illustrates an exemplary top view of a layer of room temperature operating quantum computing chip.

FIG. 23 illustrates an exemplary top view of a layer of magnetic field generator.

FIG. 24 illustrates an exemplary top view of a layer of magnetic field generator.

FIG. 25 illustrates an exemplary top view of a layer of electric field generator.

FIG. 26 illustrates an exemplary top view of a layer of electric field generator.

FIG. 27 illustrates an exemplary top view of a layer of EM field generator.

FIG. 28 illustrates an exemplary top view of a layer of EM field generator.

FIG. 29 illustrates an exemplary configuration of room temperature operating quantum computing chip.

FIG. 30 illustrates an exemplary configuration of room temperature operating quantum computing chip.

FIG. 31 illustrates an exemplary configuration of room temperature operating quantum computing chip.

FIG. 32 illustrates an exemplary top view of a layer of external field generator.

FIG. 33 illustrates an exemplary top view of a layer of external field generator.

FIG. 34 illustrates an exemplary configuration of room temperature operating quantum computing chip.

FIG. 35 illustrates an exemplary configuration of room temperature operating quantum computing chip.

FIG. 36 illustrates an exemplary top view of a layer of room temperature operating quantum computing chip.

FIG. 37 illustrates an exemplary top view of a layer of external field generator.

FIG. 38 illustrates an exemplary top view of a layer of external field generator.

FIG. 39 illustrates a three-band structure of discrete time-crystalline material of the present disclosure.

FIG. 40 illustrates a two-band structure of discrete time-crystalline material of the present disclosure.

Furthermore, the scope of the technology of the present disclosure may not be limited to the above-mentioned embodiments. Without surpassing the aim or concept of the present disclosure, various revisions may be able to be added.

### DETAILED DESCRIPTION OF THE INVENTION

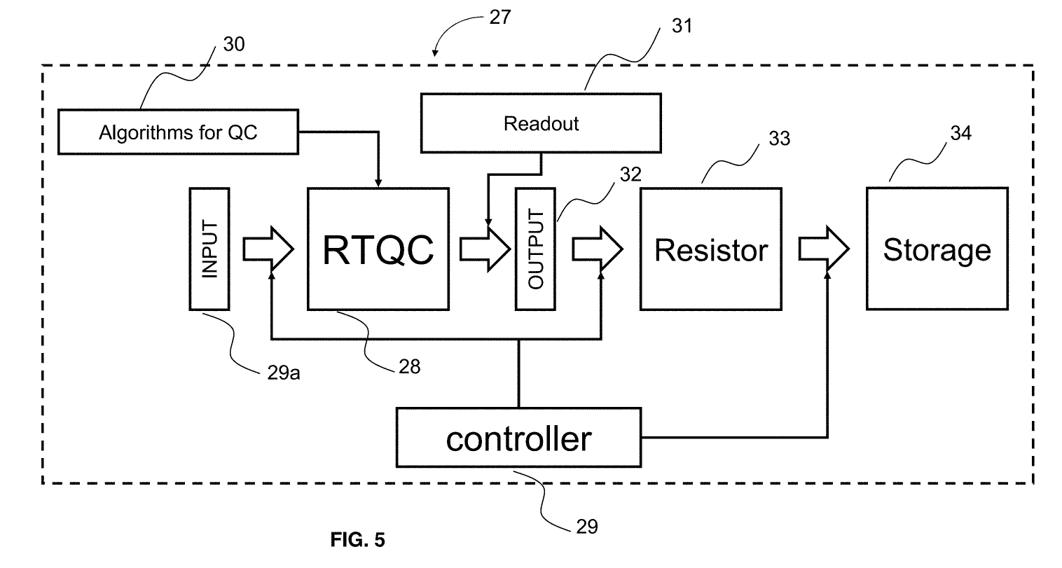

FIG. 5 illustrates a basic configuration of system 27 including an RTQC 28. A controller 29 may control an input 29a which may be input to the RTQC. The RTQC may operate calculation inside according to a given algorithm for quantum computing (QC) 30. A readout may read a calculation result which may be output to an external of RTQC as an output 32 from the RTQC. The controller may forward the output to a resistor 33. The register may convert the output to be suitable to be stored in a storage 34. The controller may command the resistor to forward the converted output to the storage.

In FIG. 5, all other than the RTQC 28 is not a quantum mechanical device and can operate in a conventional manner.

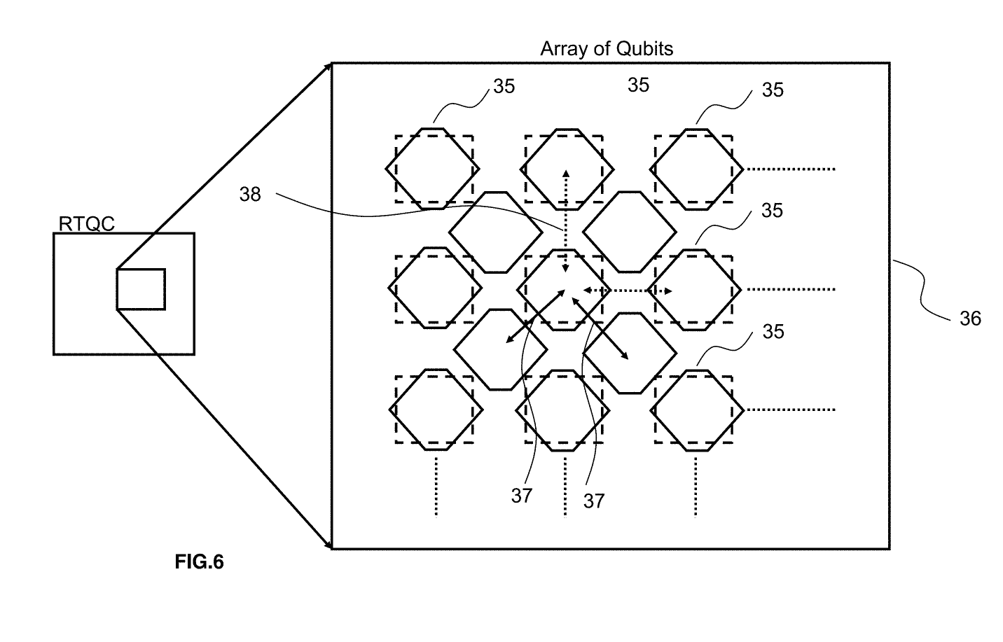

The layout pattern of qubits is not only a checker-board. FIG. 6 is another example. A qubit is hexagonal 35 and then the concentration of qubits may be more than in a checker-board pattern 36. To 9 qubits in a checker-board pattern depicted dashed squares or rectangulars, there are 13 qubits depicted bulk hexagons 36.

Note that a correlation may be stronger via a wider edge which is confronted with a neighboring qubit and through a shorter distance from a neighboring qubit. In FIG. 6, the stronger correlations 37 are depicted bulk arrows and the weaker correlations 38 are depicted dotted arrows. The configuration of correlations may be controlled by designing a shape of qubits and pattern of an array of qubits 36.

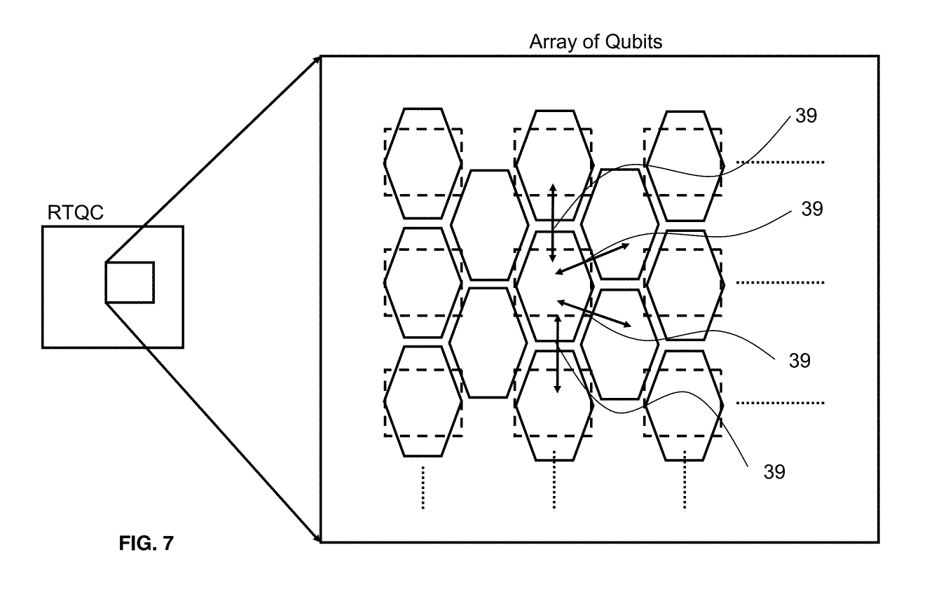

In FIG. 7, there may be more correlations (which are strong sufficiently and depicted bulk arrows 39) among neighboring qubits.

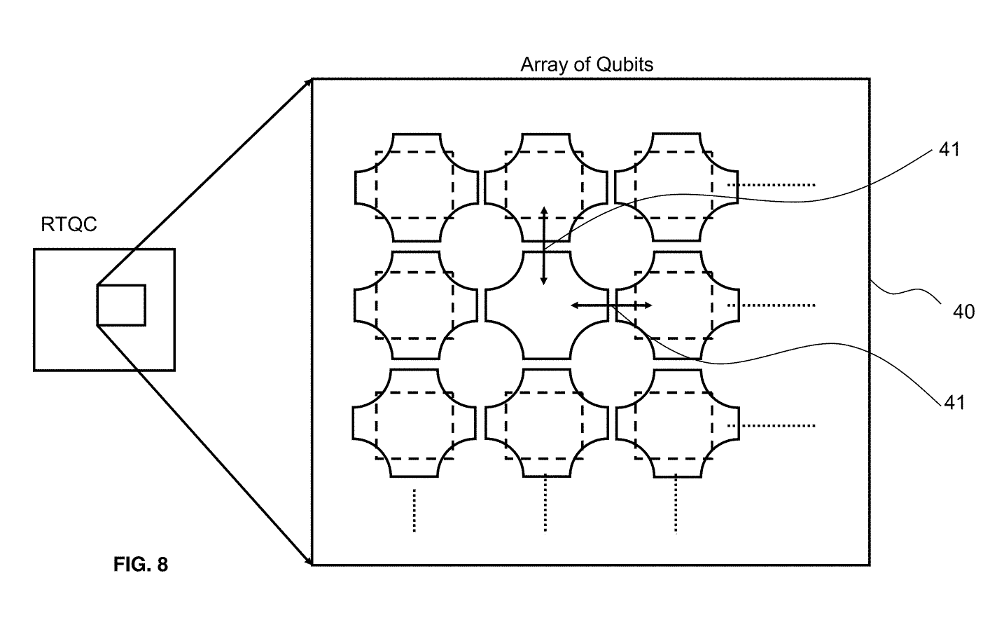

In FIG. 8, the configuration of correlations 40 is similar to a checker-board layout of square or rectangular qubits. However, each correlation 41 may be stronger than in square or rectangular qubits.

Like this, we may control the configuration and the intensity of correlations by designing or tuning the shape of qubits and the layout pattern of qubits. Also, we may three-dimensionally design the configuration of correlations by using the stacking arrays of qubits. As areas between two qubits which confront vertically each other is increased, the vertical correlation between them may become stronger. As the thickness of interlayer between layers of confronted arrays of qubits, the correlation between each of confronted qubits may become weaker. Such an interlayer may be an insulating film, a dielectric film and so forth. The property of material adopted as an interlayer may also be tuned to control vertical correlation. The stacking arrays of qubits may form a three-dimensional array of qubits.

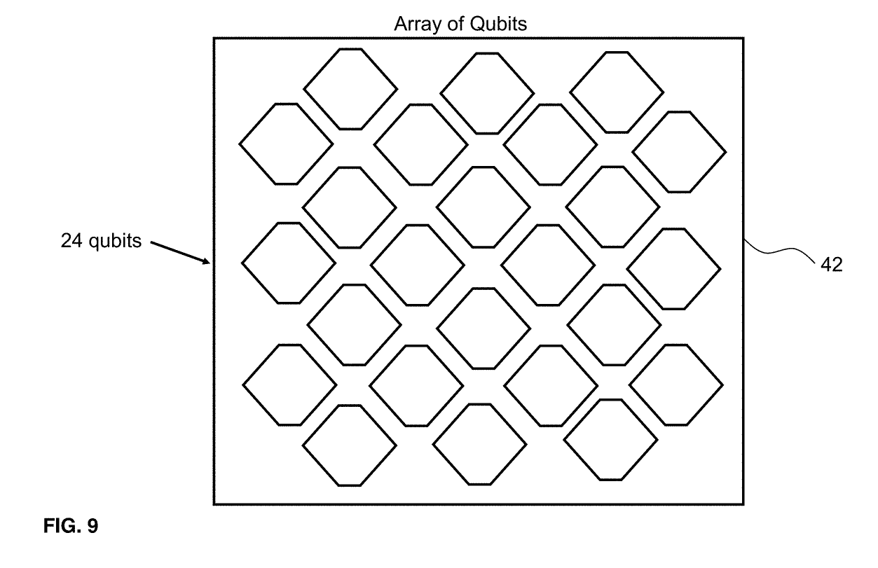

FIG. 9 illustrates an example of a layout pattern 24 comprising 24 qubits.

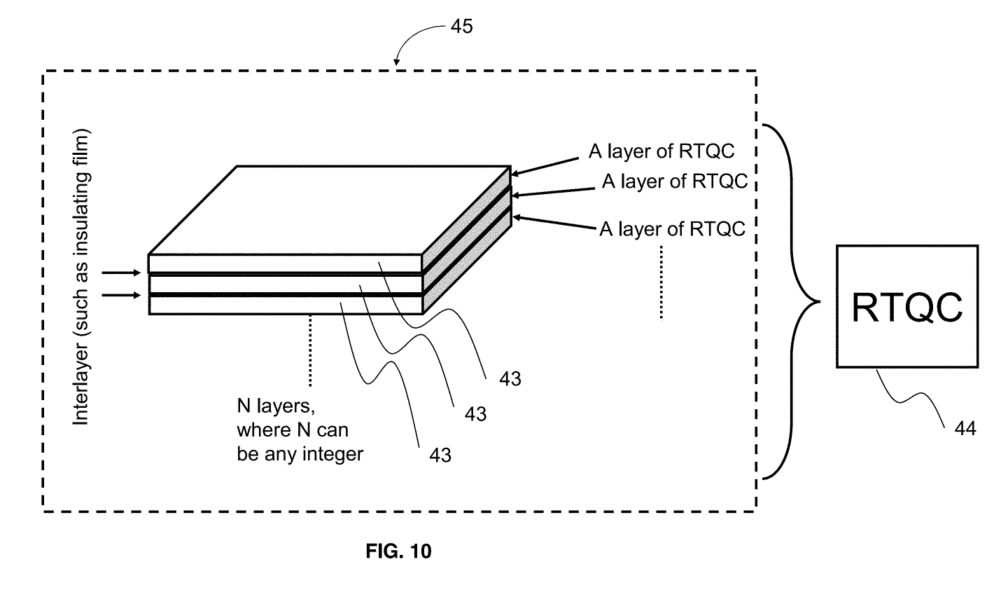

We may be able to stack layers 43 of RTQC 44 as illustrated in FIG. 10 and then may form a stacked arrays of qubits 45. If two qubits confronted vertically in the stacked arrays can correlate each other, we can design three-dimensional configuration of qubits' correlation 45.

If each layer includes an array of 24 qubits, then the stack of 3 layers may form a quantum computer of 72 qubits. Note, if qubits are configured three dimensionally, the average distance between any two qubits may be able to be shorter than any layout pattern of qubits in two-dimension.

Of course, we can stack two layers of RTQC or more than three layers of RTQC. As long as stacked layers of RTQC can form a quantum computer, we may regard a stacking layers of one or more RTQC as RTQC.

By this way, RTQC may comprise one or more layers of RTQC. From now on, RTQC may be a layer of RTQC or a stacking layers of RTQC.

A quantum computer may comprise a generator of external field which may be applied to an RTQC as well as the RTQC. Also, note that the generator of external field may need a power supply (power unit) and a connection to the power supply.

By this disclosure, a technology is provided where a room-temperature operating quantum computer chip is uniquely given to a system co-working with the conventional co-systems such as controllers, registors, storage and so forth. Then, the blockchain may be validated to protect data transaction between nodes in the peer-to-peer network even in the dynasty of quantum computing.

The preferred embodiments for carrying out the present disclosure are concretely illustrated as follows.

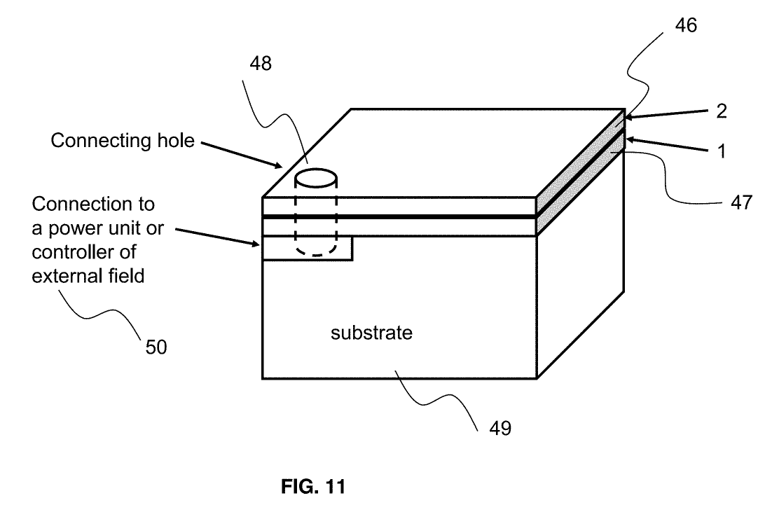

In FIG. 11, there may be two layers 46 and 47 which are connected via a vertical connecting hole 48 reaching a substrate 49 with a connection to a power unit. Such a connecting hole may be formed by a through silicon via (TSV) as an example. A power unit may supply power to be consumed to apply an external field to an RTQC. Or a controller of external field may be connected to the connecting hole.

The external field may be an electric field, a magnetic field, electro-magnetic (EM) field, and so forth.

The layer 1 47 may be selected among an EM-generator, an electric field generator, a magnetic field generator, and an RTQC.

The layer 2 46 may be selected among an EM-generator, an electric field generator, and a magnetic field generator if the layer 1 is an RTQC and may be an RTQC otherwise.

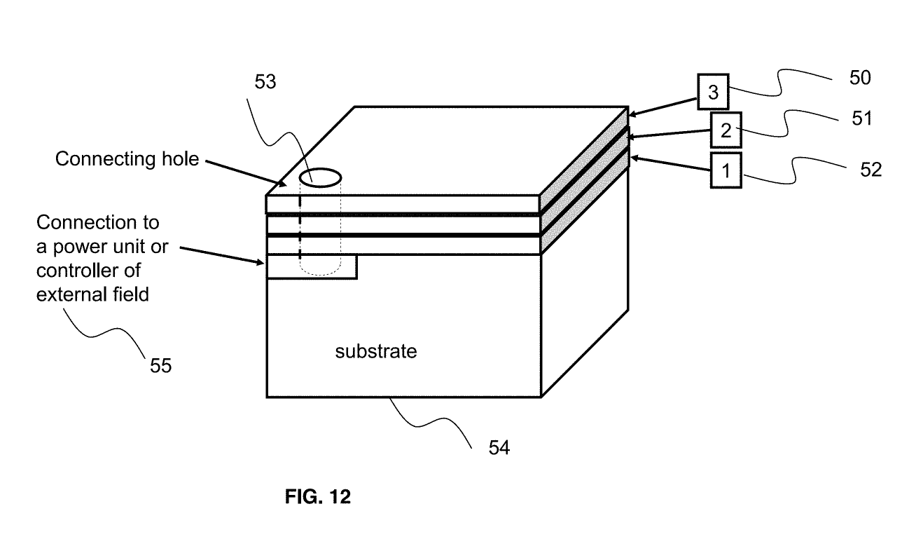

In FIG. 12, there may be three layers 50, 51 and 52 which are connected via a vertical connecting hole 53 reaching a substrate 54 with a connection to a power unit 55. Such a connecting hole may be formed by TSV as an example. A power unit may supply power to be consumed to apply an external field to an RTQC.

The layer 1 52 may be selected among an EM-generator, an electric field generator, a magnetic field generator, and an RTQC.

The layer 2 53 may be selected among an EM-generator, am electric field generator, a magnetic field generator if the layer 1 is an RTQC and may be selected among an EM-generator, an electric field generator, a magnetic field generator, and an RTQC otherwise.

The layer 3 50 may be selected among an EM-generator, an electric field generator, a magnetic field generator if the layer 1 or the layer 2 is an RTQC and may be an RTQC otherwise.

Note that a connecting hole may generate an EM field, an electric field or magnetic field. If the distance from an array of qubits is short, the qubits may be influenced by an external field generated by a connecting hole. Therefore, the distance between a connecting hole and an array of qubits may be as large as possible.

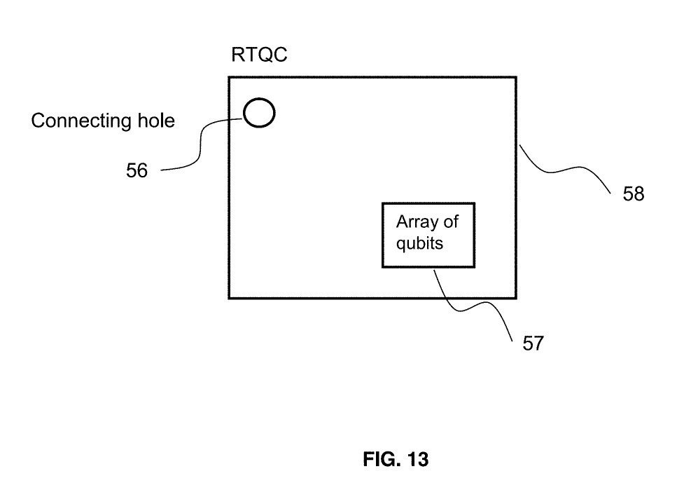

FIG. 13 illustrates a top view of RTQC 58 as an example. Note that a connecting hole 56 locates at a corner and an array of qubits 57 locates at another corner, as long as the top view of RTQC is a square or a rectangular. Otherwise, the layout of the connecting hole and the array of qubits may be designed to maximize the distance between them.

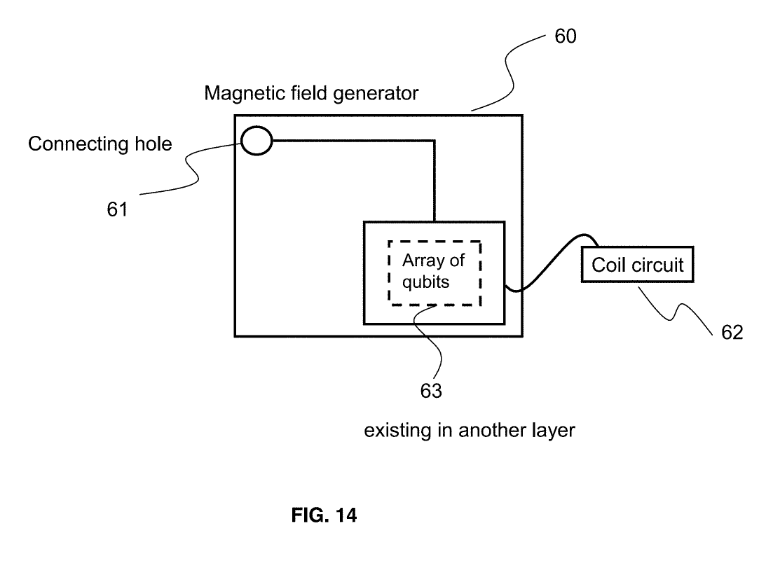

FIG. 14 illustrates a top view of a magnetic field generator 60, which may comprise a connecting hole 61 and a coil circuit 62 to generate a magnetic field. Note that the connecting hole locates at a corner and the coil circuit locates at another corner, as long as the top view of the magnetic field generator is a square or a rectangular. Otherwise, the layout of the connecting hole and the coil circuit may be designed to maximize the distance between them. Also note that the coil circuit may be located to overlap an array of qubits 63 in an RTQC stacked together with the magnetic field generator. In this event, a controller of external field (i.g., controller of coil circuit) may be integrated on a surface of the substrate as illustrated in FIG. 11 part 49 or FIG. 12 part 54. A power unit may supply power to the coil circuit going through a connection to the power unit, which is also integrated on a surface of substrate 49 or 54.

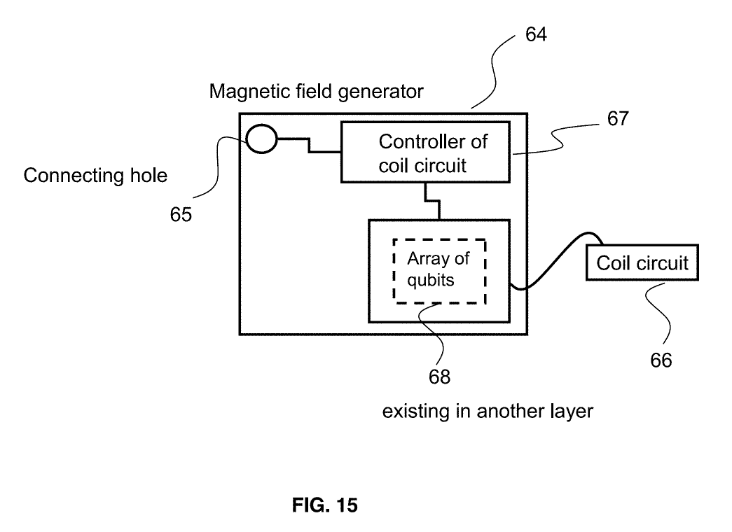

FIG. 15 illustrates a top view of a magnetic field generator 64, which may comprise a connecting hole 65, a coil circuit 66 to generate a magnetic field, and a controller of coil circuit 67. Note that the connecting hole locates at a corner and the coil circuit locates at another corner, as long as the top view of the magnetic field generator is a square or a rectangular. Otherwise, the layout of the connecting hole and the coil circuit may be designed to maximize the distance between them. Also note that the coil circuit may be located to overlap an array of qubits 68 in an RTQC stacked together with the magnetic field generator. A power unit may supply power to the coil circuit going through a connection to the power unit and the connecting hole.

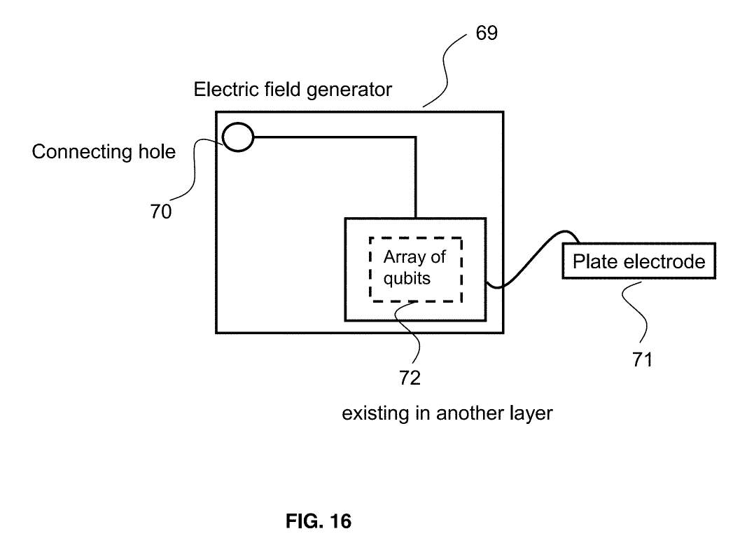

FIG. 16 illustrates a top view of an electric field generator 69, which may comprise a connecting hole 70 and a plate electrode 71 to generate an electric field. Note that the connecting hole locates at a corner and the plate electrode locates at another corner, as long as the top view of the electric field generator is a square or a rectangular. Otherwise, the layout of the connecting hole and the plate electrode may be designed to maximize the distance between them. Also note that the plate electrode may be located to overlap an array of qubits 72 in an RTQC stacked together with the electric field generator. In this event, a controller of external field (i.g., controller of electric field) may be integrated on a surface of the substrate as illustrated in FIG. 11 part 49 or FIG. 12 part 54. A power unit may supply power via the plate electrode going through a connection to the power unit, which is also integrated on a surface of substrate 49 or 54.

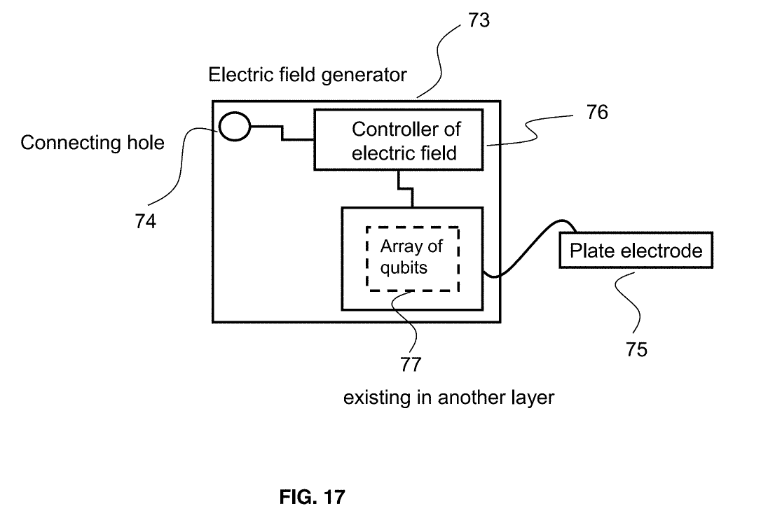

FIG. 17 illustrates a top view of an electric field generator 73, which may comprise a connecting hole 74, a plate electrode 75 to generate an electric field, and a controller of electric field 76. Note that the connecting hole locates at a corner and the plate electrode locates at another corner, as long as the top view of the electric field generator is a square or a rectangular. Otherwise, the layout of the connecting hole and the plate electrode may be designed to maximize the distance between them. Also note that the plate electrode may be located to overlap an array of qubits 77 in an RTQC stacked together with the magnetic field generator. A power unit may supply power via the plate electrode going through a connection to the power unit and the connecting hole.

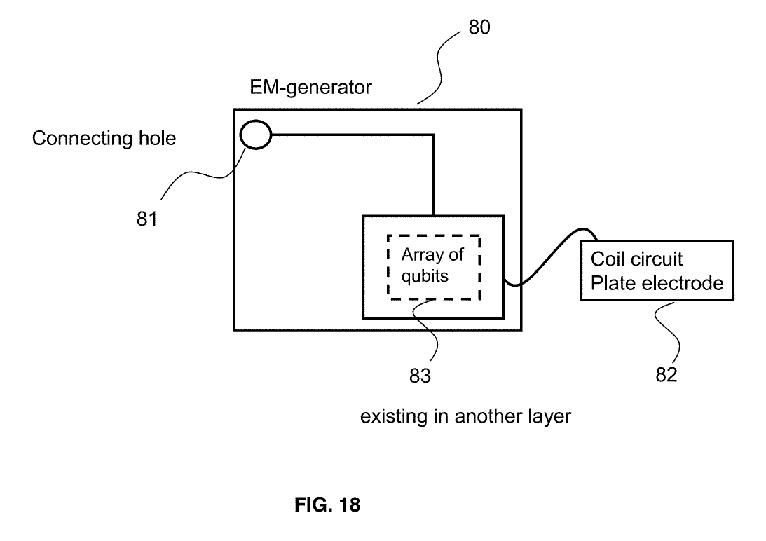

FIG. 18 illustrates a top view of an EM field generator 80, which may comprise a connecting hole 81 and a coil circuit and a plate electrode 82 to generate an EM field. Note that the connecting hole locates at a corner and the coil circuit and the plate electrode locate at another corner, as long as the top view of the EM field generator is a square or a rectangular. Otherwise, the layout of the connecting hole, the coil circuit and the plate electrode may be designed to maximize the distance between the connecting hole and the others. Also note that the coil circuit and the plate electrode may be located to overlap an array of qubits 83 in an RTQC stacked together with the electric field generator. In this event, a controller of external field (i.g., controller of EM field) may be integrated on a surface of the substrate as illustrated in FIG. 11 part 49 or FIG. 12 part 54. A power unit may supply power to the coil circuit or via the plate electrode going through a connection to the power unit, which is also integrated on a surface of substrate 49 or 54.

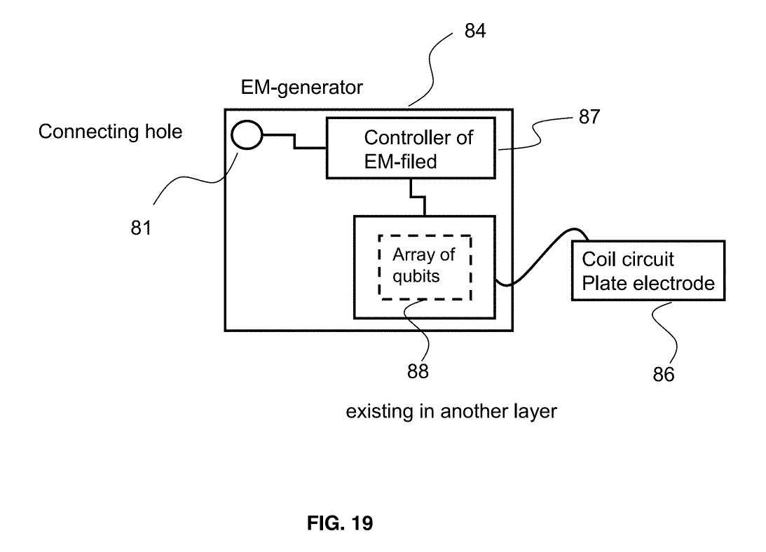

FIG. 19 illustrates a top view of an EM field generator 84, which may comprise a connecting hole 85, a coil circuit and a plate electrode 86 to generate an EM field, and a controller of EM field 87. Note that the connecting hole locates at a corner and the coil circuit and the plate electrode locate at another corner, as long as the top view of the EM field generator is a square or a rectangular. Otherwise, the layout of the connecting hole, the coil circuit and the plate electrode may be designed to maximize the distance between the connecting hole and the others. Also note that the coil circuit and the plate electrode may be located to overlap an array of qubits 88 in an RTQC stacked together with the EM field generator. A power unit may supply power via the coil circuit and the plate electrode going through a connection to the power unit and the connecting hole.

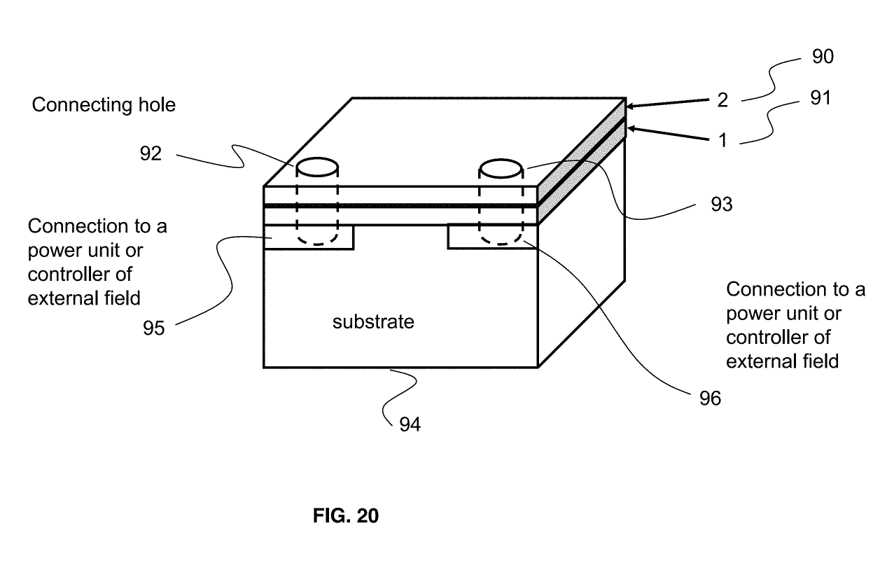

In FIG. 20, there may be two layers 90 and 91 which are connected via two vertical connecting holes 92 and 93 reaching a substrate 94 with connections to power units 95 and 96, respectively. Such connecting holes may be formed by TSV as an example. A power unit may supply power to be consumed to apply an external field to an RTQC. Or a controller of external field may be connected to at least one of the connecting holes.

The external field may be an electric field, a magnetic field, EM field, and so forth.

The layer 1 91 may be selected among an EM-generator, an electric field generator, a magnetic field generator, and an RTQC.

The layer 2 92 may be selected among an EM-generator, an electric field generator, and a magnetic field generator if the layer 1 is an RTQC and may be an RTQC otherwise.

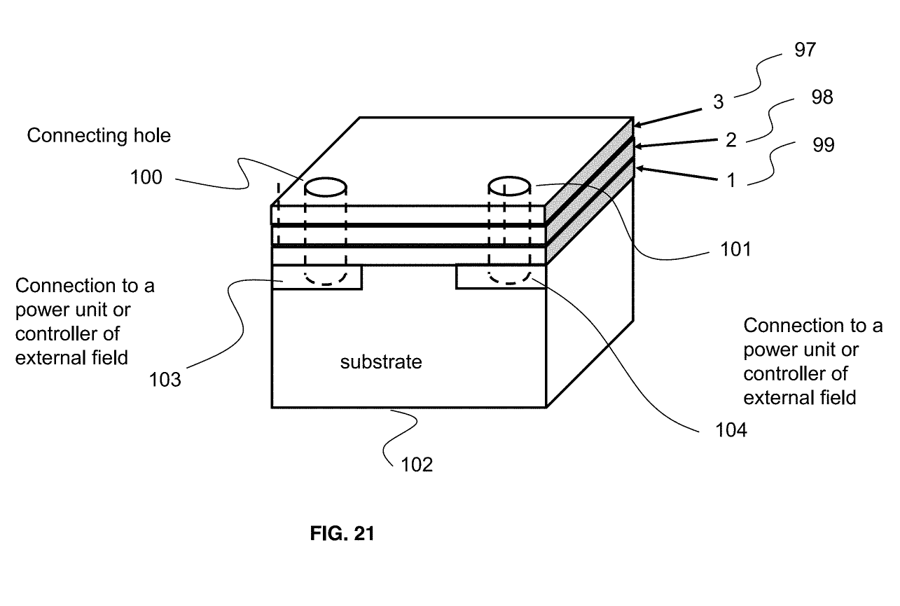

In FIG. 21, there may be three layers 97, 98 and 99 which are connected via two vertical connecting holes 100 and 101 reaching a substrate 102 with connections to power units 103 and 104, respectively. Such connecting holes may be formed by TSV as an example. A power unit may supply power to be consumed to apply an external field to an RTQC. Or a controller of external field may be connected to at least one of the connecting holes.

The layer 1 99 may be selected among an EM-generator, an electric field generator, a magnetic field generator, and an RTQC.

The layer 2 98 may be selected among an EM-generator, am electric field generator, a magnetic field generator if the layer 1 is an RTQC and may be selected among an EM-generator, an electric field generator, a magnetic field generator, and an RTQC otherwise.

The layer 3 97 may be selected among an EM-generator, an electric field generator, a magnetic field generator if the layer 1 or the layer 2 is an RTQC and may be an RTQC otherwise.

Note that a connecting hole may generate an EM field, an electric field or magnetic field. If the distance from an array of qubits is short, the qubits may be influenced by an external field generated by a connecting hole. Therefore, the distance between a connecting hole and an array of qubits may be as large as possible.

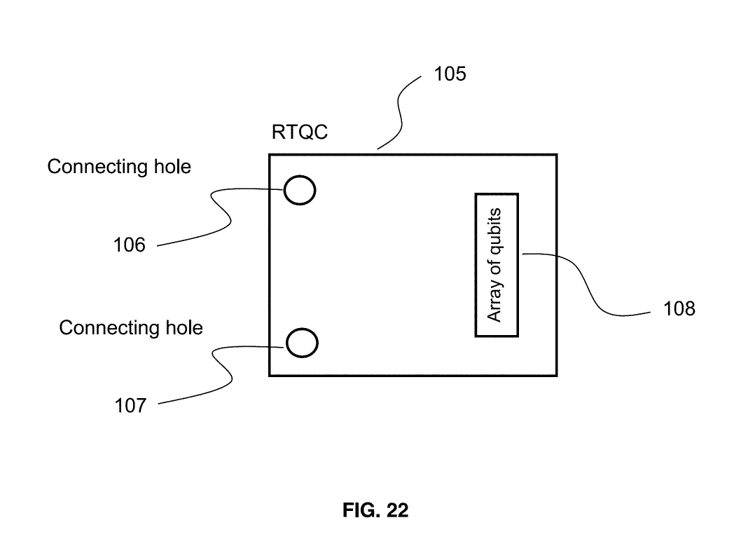

FIG. 22 illustrates a top view of RTQC 105 as an example. Note that two connecting holes 106 and 107 may respectively locate at two corners and an array of qubits 108 locates near between the other corners, as long as the top view of RTQC is a square or rectangular 105. Otherwise, the layout of the connecting holes and the array of qubits may be designed to maximize the distance between them.

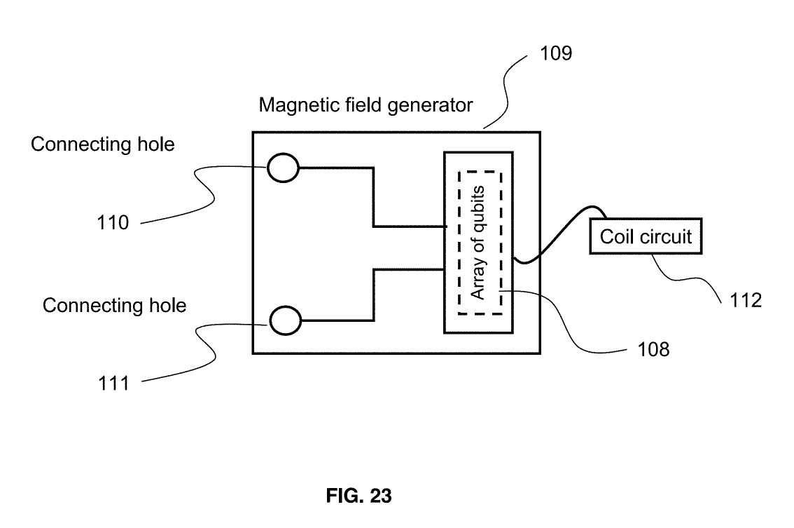

FIG. 23 illustrates a top view of a magnetic field generator 109, which may comprise two connecting holes 110 and 111 and a coil circuit 112 to generate a magnetic field. Note that the connecting holes may respectively locate at two corners and the coil circuit may locate near between the other corners, as long as the top view of the magnetic field generator is a square or rectangular. Otherwise, the layout of the connecting holes and the coil circuit may be designed to maximize the distance between them. Also note that the coil circuit may be located to overlap an array of qubits 108 in an RTQC stacked together with the magnetic field generator. In this event, a controller of external field (i.g., controller of coil circuit) 95, 96, 103 or 104 may be integrated on a surface of the substrate as illustrated in FIG. 20 part 94 or FIG. 21 part 102. A power unit may supply power to the coil circuit going through a connection to the power unit, which is also integrated on a surface of substrate.

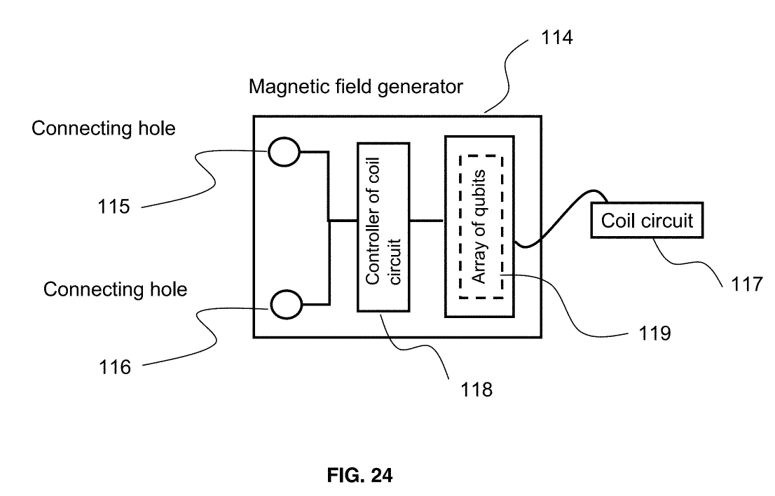

FIG. 24 illustrates a top view of a magnetic field generator 114, which may comprise two connecting holes 115 and 116, a coil circuit 117 to generate a magnetic field, and a controller of coil circuit 118. Note that the connecting holes may respectively locate at two corners and the coil circuit locates near between the other corners, as long as the top view of the magnetic field generator is a square or rectangular. Otherwise, the layout of the connecting holes and the coil circuit may be designed to maximize the distance between them. Also note that the coil circuit may be located to overlap an array of qubits 119 in an RTQC stacked together with the magnetic field generator. A power unit may supply power to the coil circuit going through a connection to the power unit and the connecting holes.

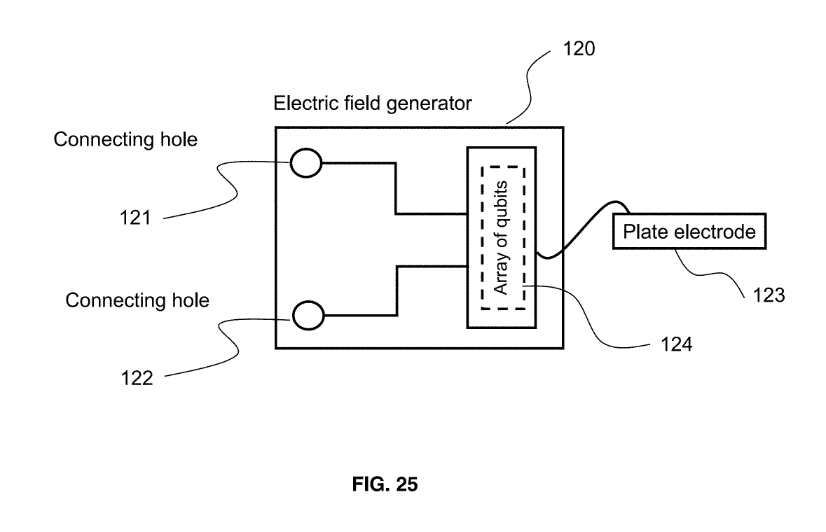

FIG. 25 illustrates a top view of an electric field generator 120, which may comprise two connecting holes 121 and 122 and a plate electrode 123 to generate an electric field. Note that the connecting holes may respectively locate at two corners and the plate electrode may locate near between the other corners, as long as the top view of the electric field generator is a square or a rectangular. Otherwise, the layout of the connecting holes and the plate electrode may be designed to maximize the distance between them. Also note that the plate electrode may be located to overlap an array of qubits 124 in an RTQC stacked together with the electric field generator. In this event, a controller of external field (i.g., controller of electric field) 95, 96, 103 or 104 may be integrated on a surface of the substrate as illustrated in FIG. 20 part 94 or FIG. 21 part 102. A power unit may supply power via the plate electrode going through a connection to the power unit, which is also integrated on a surface of substrate.

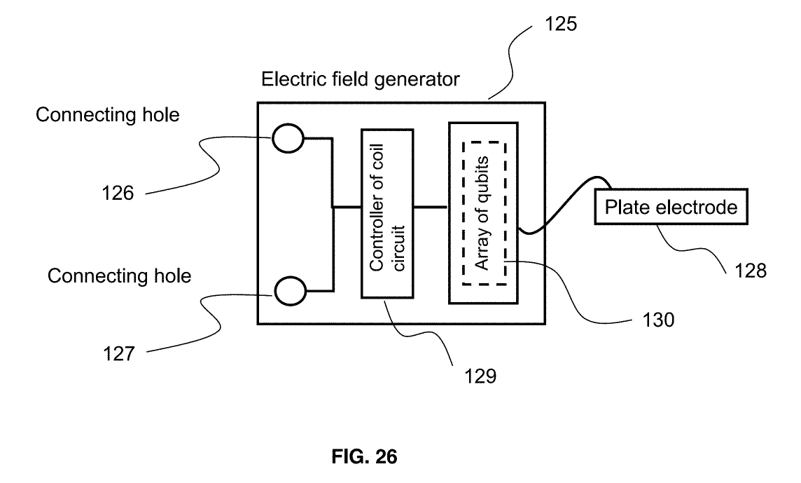

FIG. 26 illustrates a top view of an electric field generator 125, which may comprise two connecting holes 126 and 127, a plate electrode 128 to generate an electric field, and a controller of electric field. Note that the connecting holes may respectively locate at two corners and the plate electrode may locate near between the other corners, as long as the top view of the electric field generator is a square or a rectangular. Otherwise, the layout of the connecting holes and the plate electrode may be designed to maximize the distance between them. Also note that the plate electrode may be located to overlap an array of qubits 130 in an RTQC stacked together with the magnetic field generator. A power unit may supply power via the plate electrode going through a connection to the power unit and the connecting hole.

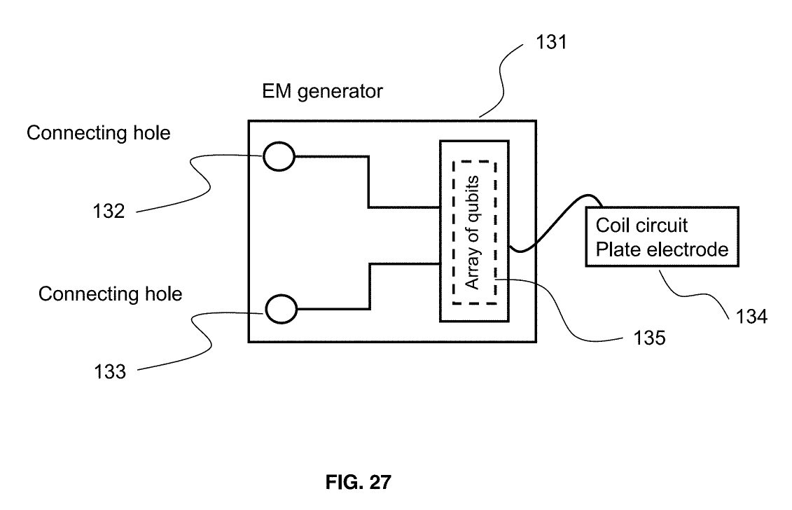

FIG. 27 illustrates a top view of an EM field generator 131, which may comprise two connecting holes 132 and 133 and a coil circuit and a plate electrode 134 to generate an EM field. Note that the connecting holes may respectively locate at two corners and the coil circuit and the plate electrode may locate near between the corners, as long as the top view of the EM field generator is a square or a rectangular. Otherwise, the layout of the connecting holes, the coil circuit and the plate electrode may be designed to maximize the distance between the connecting holes and the others. Also note that the coil circuit and the plate electrode may be located to overlap an array of qubits 135 in an RTQC stacked together with the electric field generator. In this event, a controller of external field (i.g., controller of EM field) 95, 96, 103 or 104 may be integrated on a surface of the substrate as illustrated in FIG. 20 part 94 or FIG. 21 part 102. A power unit may supply power to the coil circuit or via the plate electrode going through a connection to the power unit, which is also integrated on a surface of substrate.

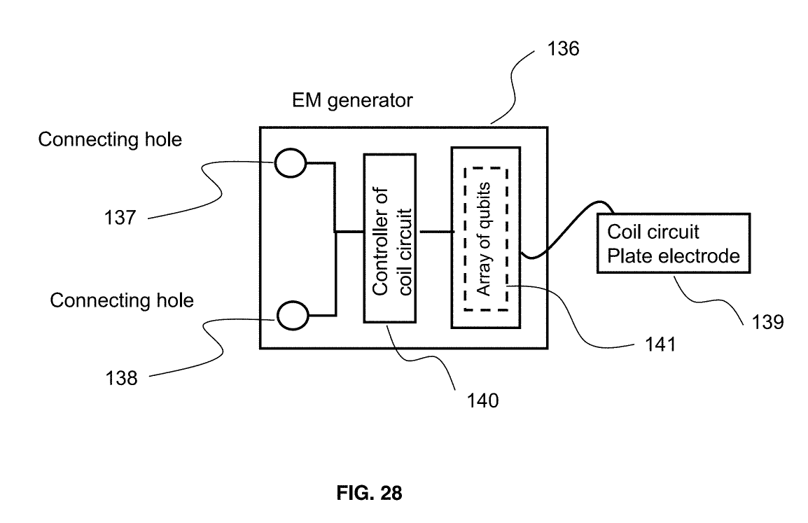

FIG. 28 illustrates a top view of an EM field generator 136, which may comprise two connecting holes 137 and 138, a coil circuit and a plate electrode 139 to generate an EM field, and a controller of EM field 140. Note that the connecting holes may respectively locate at two corners and the coil circuit and the plate electrode locate near between the other corners, as long as the top view of the EM field generator is a square or a rectangular. Otherwise, the layout of the connecting holes, the coil circuit and the plate electrode may be designed to maximize the distance between the connecting hole and the others. Also note that the coil circuit and the plate electrode may be located to overlap an array of qubits 141 in an RTQC stacked together with the EM field generator. A power unit may supply power via the coil circuit and the plate electrode going through a connection to the power unit and the connecting hole.

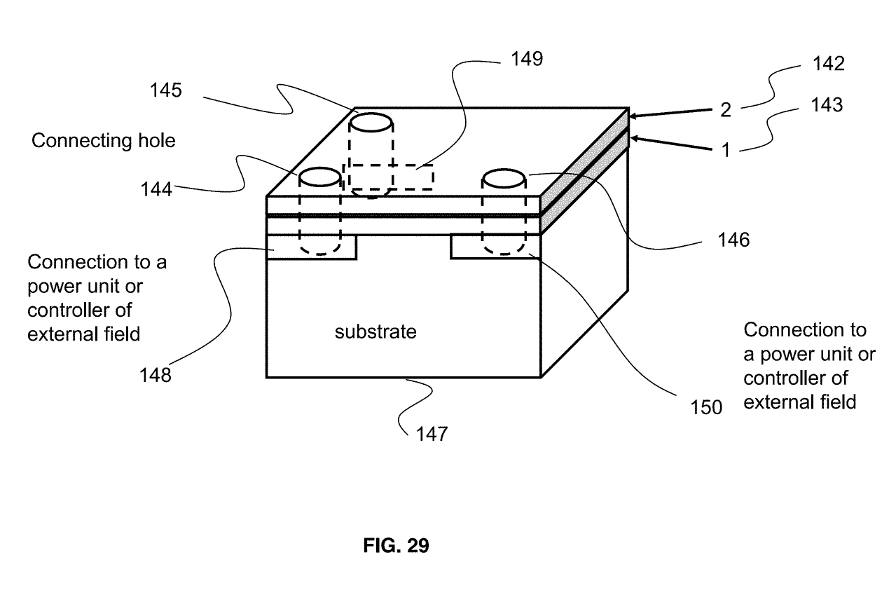

In FIG. 29, there may be two layers 142 and 143 which are connected via three vertical connecting holes 144, 145 and 146 reaching a substrate 147 with connections to power units 148, 149 and 150, respectively. Such connecting holes may be formed by TSV as an example. A power unit may supply power to be consumed to apply an external field to an RTQC. Or a controller of external field may be connected to at least one of the connecting holes.

The external field may be an electric field, a magnetic field, EM field, and so forth.

The layer 1 143 may be selected among an EM-generator, an electric field generator, a magnetic field generator, and an RTQC.

The layer 2 142 may be selected among an EM-generator, an electric field generator, and a magnetic field generator if the layer 1 is an RTQC and may be an RTQC otherwise.

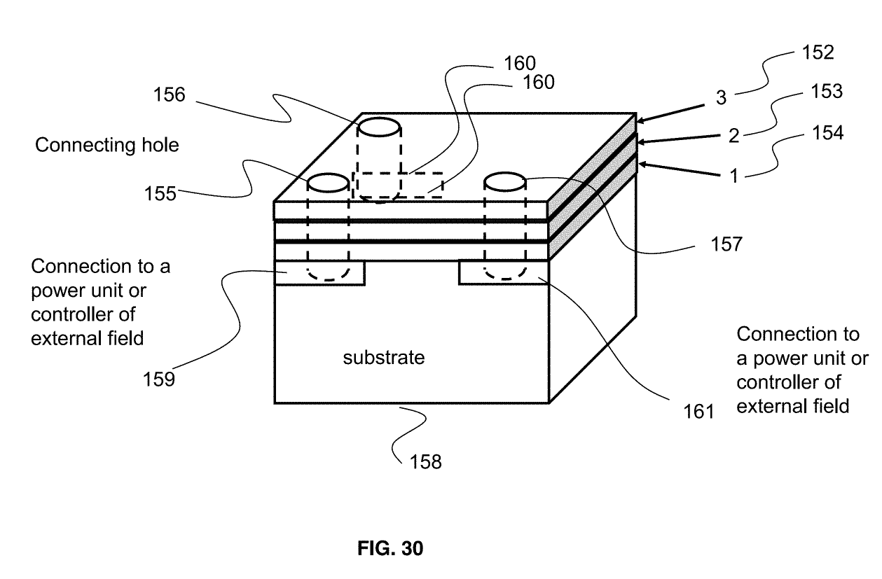

In FIG. 30, there may be three layers 152, 153 and 154 which are connected via three vertical connecting holes 155, 156 and 157 reaching a substrate 158 with connections to power units 159, 160 and 161. Such connecting holes may be formed by TSV as an example. A power unit may supply power to be consumed to apply an external field to an RTQC. Or a controller of external field may be connected to at least one of the connecting holes.

The layer 1 154 may be selected among an EM-generator, an electric field generator, a magnetic field generator, and an RTQC.

The layer 2 153 may be selected among an EM-generator, am electric field generator, a magnetic field generator if the layer 1 is an RTQC and may be selected among an EM-generator, an electric field generator, a magnetic field generator, and an RTQC otherwise.

The layer 3 152 may be selected among an EM-generator, an electric field generator, a magnetic field generator if the layer 1 or the layer 2 is an RTQC and may be an RTQC otherwise.

Note that a connecting hole may generate an EM field, an electric field or magnetic field. If the distance from an array of qubits is short, the qubits may be influenced by an external field generated by a connecting hole. Therefore, the distance between a connecting hole and an array of qubits may be as large as possible.

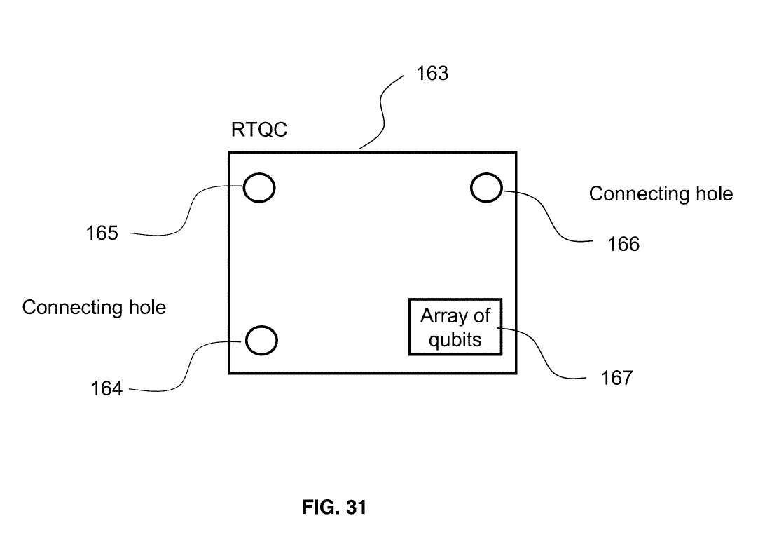

FIG. 31 illustrates a top view of RTQC 163 as an example. Note that three connecting holes 164, 165 and 166 may respectively locate at three corners and an array of qubits 167 may locate at the other corner, as long as the top view of RTQC is a square or a rectangular. Otherwise, the layout of the connecting holes and the array of qubits may be designed to maximize the distance between them.

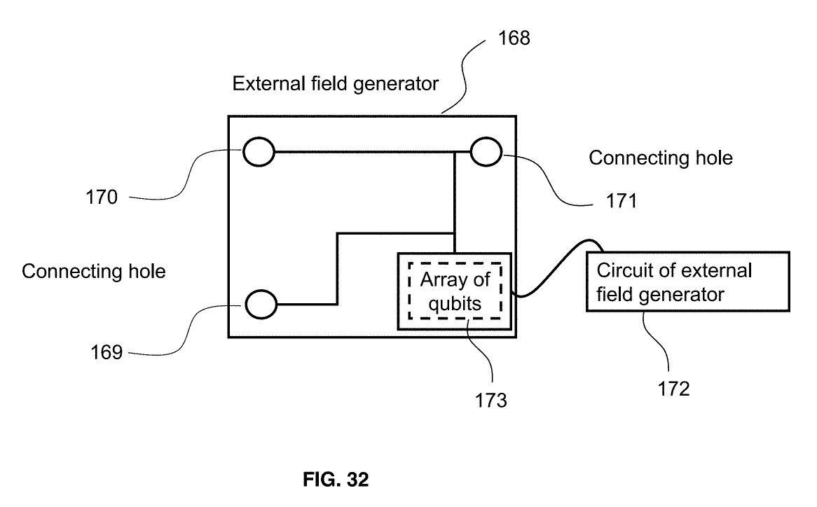

FIG. 32 illustrates a top view of an external field generator 168, which may comprise three connecting holes 169, 170 and 171 and a circuit of external field generator 172 to generate an external field. Note that the connecting holes may respectively locate at three corners and the circuit of external field generator may locate at the other corner, as long as the top view of the external field generator is a square or a rectangular. Otherwise, the layout of the connecting holes and the circuit of external field generator may be designed to maximize the distance between them. Also note that the circuit of external field generator may be located to overlap an array of qubits 173 in an RTQC stacked together with the external field generator. In this event, a controller of external field may be integrated on a surface of the substrate as illustrated in FIG. 29 part 147 or FIG. 30 part 158. A power unit may supply power to the circuit of external field generator going through a connection to the power unit, which is also integrated on a surface of substrate.

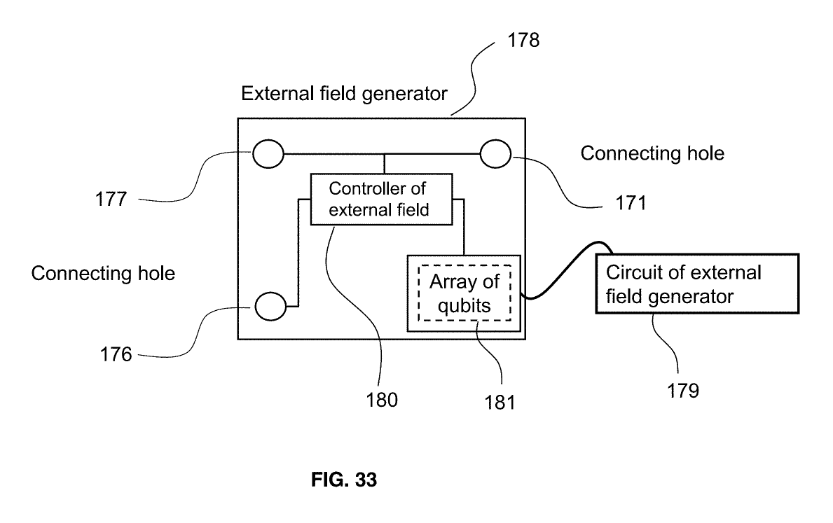

FIG. 33 illustrates a top view of an external field generator 175, which may comprise three connecting holes 176, 177 and 178, a circuit of external field generator 179 to generate an external field, and a controller of external field 180. Note that the connecting holes may respectively locate at three corners and the circuit of external field generator may locate at other corner, as long as the top view of the external field generator is a square or a rectangular. Otherwise, the layout of the connecting holes and the circuit of external field generator may be designed to maximize the distance between them. Also note that the circuit of external field generator may be located to overlap an array of qubits 181 in an RTQC stacked together with the external field generator. A power unit may supply power to the circuit of external field generator going through a connection to the power unit and the connecting holes.

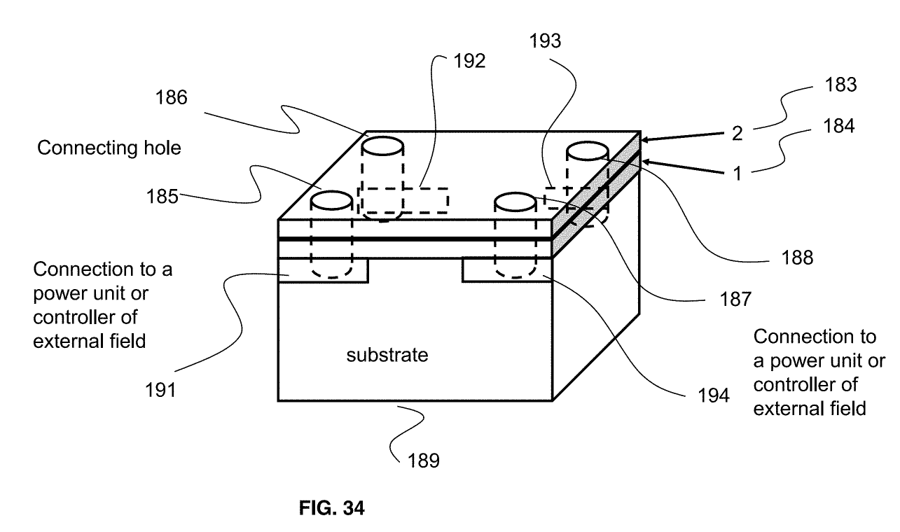

In FIG. 34, there may be two layers 183 and 184 which are connected via four vertical connecting holes 185, 186, 187 and 188 reaching a substrate 189 with connections to power units 191, 192, 193 and 194. Such connecting holes may be formed by TSV as an example. A power unit may supply power to be consumed to apply an external field to an RTQC. Or a controller of external field may be connected to at least one of the connecting holes.

The external field may be an electric field, a magnetic field, EM field, and so forth.

The layer 1 184 may be selected among an EM-generator, an electric field generator, a magnetic field generator, and an RTQC.

The layer 2 183 may be selected among an EM-generator, an electric field generator, and a magnetic field generator if the layer 1 is an RTQC and may be an RTQC otherwise.

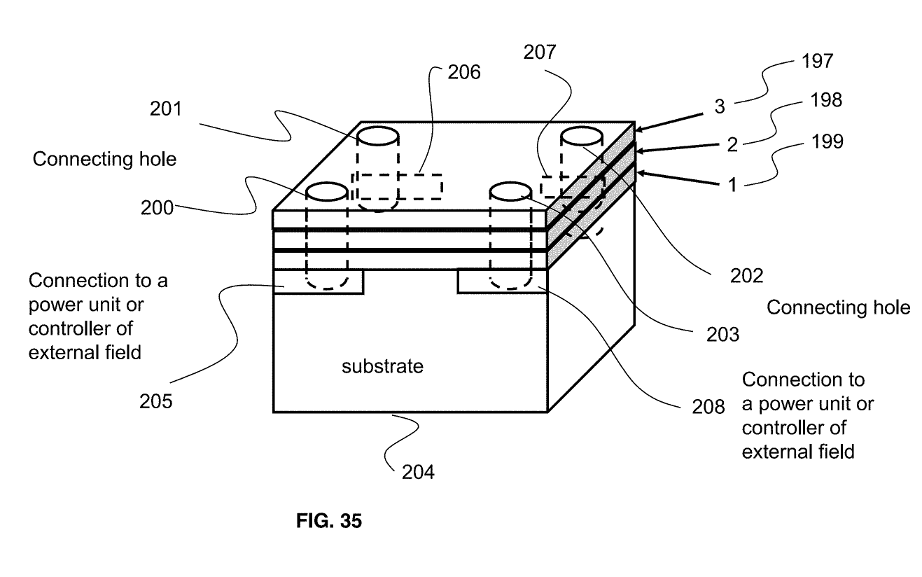

In FIG. 35, there may be three layers 197, 198 and 199 which are connected via four vertical connecting holes 200, 201, 202 and 203 reaching a substrate 204 with connections to power units 205, 206, 207 and 208, respectively. Such connecting holes may be formed by TSV as an example. A power unit may supply power to be consumed to apply an external field to an RTQC. Or a controller of external field may be connected to at least one of the connecting holes.

The layer 1 199 may be selected among an EM-generator, an electric field generator, a magnetic field generator, and an RTQC.

The layer 2 198 may be selected among an EM-generator, am electric field generator, a magnetic field generator if the layer 1 is an RTQC and may be selected among an EM-generator, an electric field generator, a magnetic field generator, and an RTQC otherwise.

The layer 3 197 may be selected among an EM-generator, an electric field generator, a magnetic field generator if the layer 1 or the layer 2 is an RTQC and may be an RTQC otherwise.

Note that a connecting hole may generate an EM field, an electric field or magnetic field. If the distance from an array of qubits is short, the qubits may be influenced by an external field generated by a connecting hole. Therefore, the distance between a connecting hole and an array of qubits may be as large as possible.

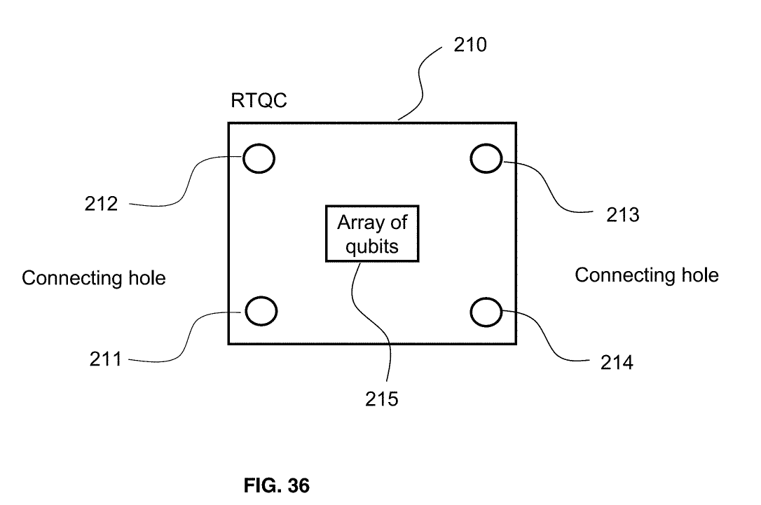

FIG. 36 illustrates a top view of RTQC 210 as an example. Note that four connecting holes 211, 212, 213 and 214 may respectively locate at four corners and an array of qubits 215 may locate near among the corners, as long as the top view of RTQC is a square or a rectangular. Otherwise, the layout of the connecting holes and the array of qubits may be designed to maximize the distance between them.

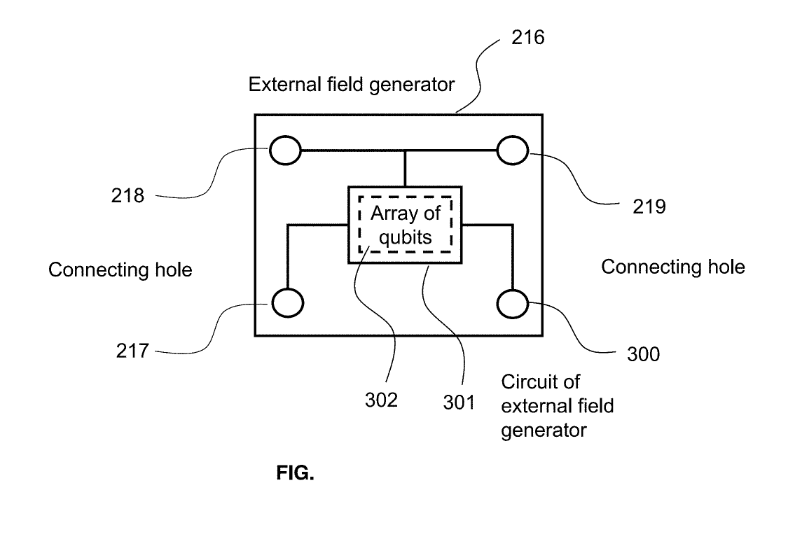

FIG. 37 illustrates a top view of an external field generator 216, which may comprise four connecting holes 217, 218, 219 and 300 and a circuit of external field generator 301 to generate an external field. Note that the connecting holes may respectively locate at four corners and the circuit of external field generator may locate among the corners, as long as the top view of the external field generator is a square or a rectangular. Otherwise, the layout of the connecting holes and the circuit of external field generator may be designed to maximize the distance between them. Also note that the circuit of external field generator may be located to overlap an array of qubits 302 in an RTQC stacked together with the external field generator. In this event, a controller of external field may be integrated on a surface of the substrate as illustrated in FIG. 34 part 189 or FIG. 35 part 204. A power unit may supply power to the circuit of external field generator going through a connection to the power unit, which is also integrated on a surface of substrate.

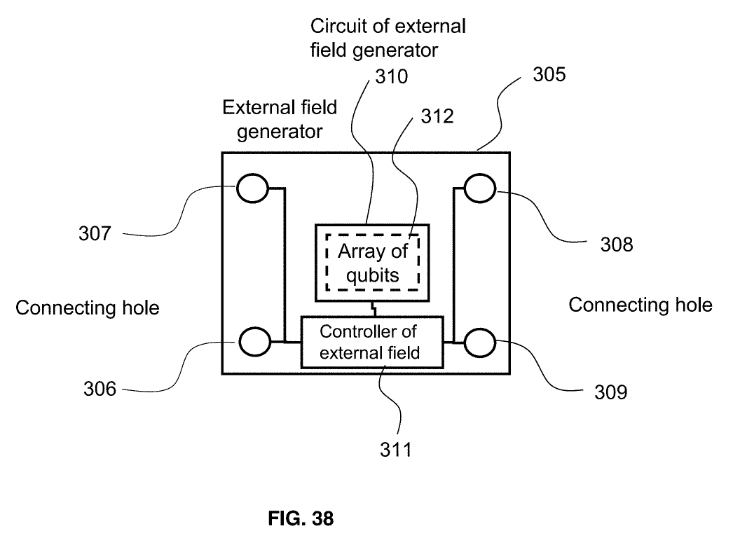

FIG. 38 illustrates a top view of an external field generator 305, which may comprise four connecting holes 306, 307, 308 and 309, a circuit of external field generator 310 to generate an external field, and a controller of external field 311. Note that the connecting holes may respectively locate at four corners and the circuit of external field generator may locate among the corners, as long as the top view of the external field generator is a square or a rectangular. Otherwise, the layout of the connecting holes and the circuit of external field generator may be designed to maximize the distance between them. Also note that the circuit of external field generator may be located to overlap an array of qubits 312 in an RTQC stacked together with the external field generator. A power unit may supply power to the circuit of external field generator going through a connection to the power unit and the connecting holes.

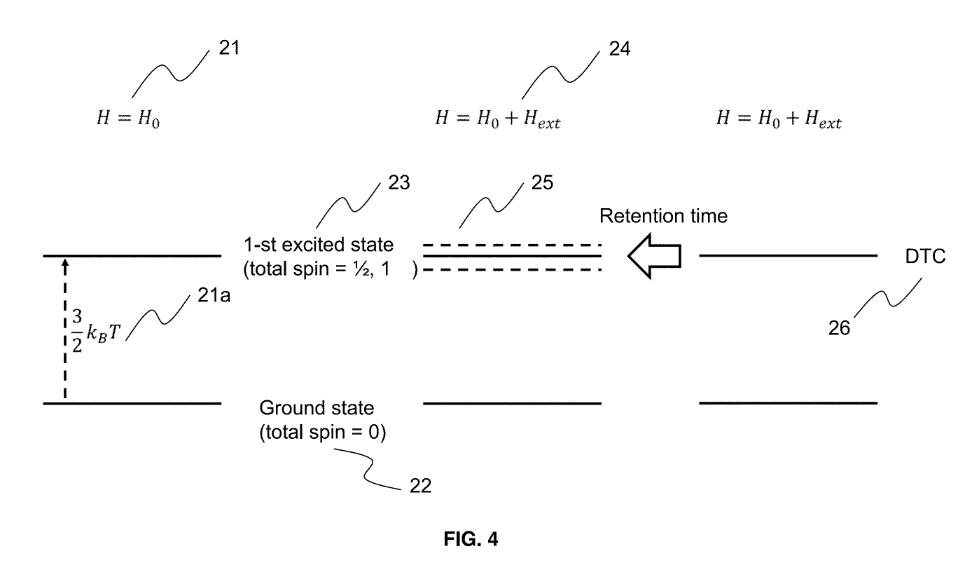

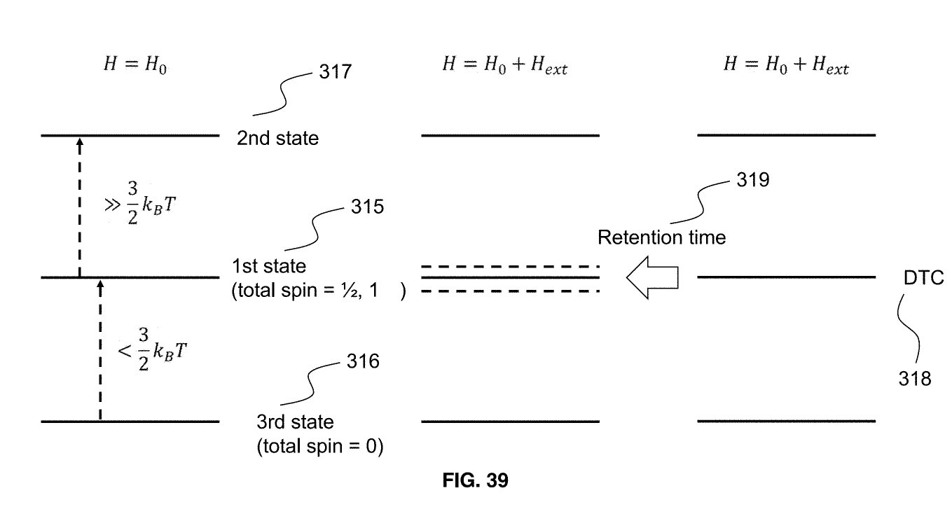

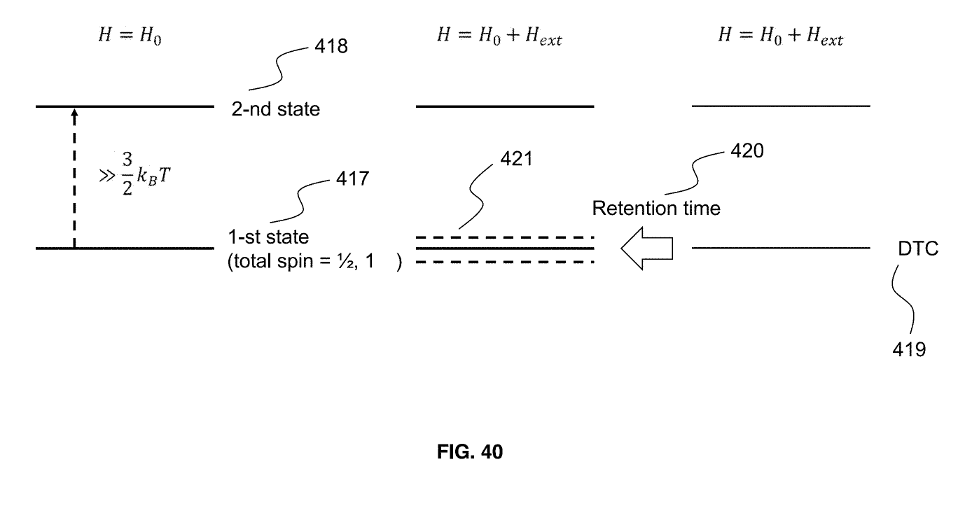

FIG. 4 illustrates an exemplary band structure which a qubit of the present disclosure may have. However, this band structure may be unable to be a qubit at a low temperature which is much less than room temperature. In order for qubit to operate at such a low temperature, the energy difference between the first excited state 315 in FIG. 39 having a spin (a first state in FIG. 39) and the ground state 316 (a third state in FIG. 39) must be smaller than thermal energy as necessary, as illustrated in FIG. 39. In order for qubit to operate at a high temperature which is higher than room temperature, the energy difference between the first state and a second excited state 317 (a second state in FIG. 39) may be necessary to be larger or much larger than thermal energy. Note that the first state may exhibit a DTC phase 318. That is, the first state may hardly change (split) for a retention time 319 even under an external field to which spin is sensitive. Note that the second state may be against the stability of DTC 318 at the first state, as long as the second state has spin. Note that the third state may be against the stability of DTC at the first state, as long as the third state has spin. That is, those states may potentially shorten the retention time of DTC. Or, DTC may exist at a ground state 417 (a first state in FIG. 40) having spin, as illustrated in FIG. 40. In order for qubit to operate at a higher temperature which is much higher than room temperature, the energy difference between the first state and a first excited state 418 (a second state in FIG. 40) may be necessary to be larger or much larger than thermal energy. Note that the first state may exhibit a DTC phase 419. That is, the first state may hardly change (split) 421 for a retention time 420 even under an external field to which spin is sensitive. Note that the second state may be against the stability of DTC at the first state, as long as the second state has spin. Accordingly, it may be preferable that, in a band structure of qubit of the present disclosure, there may be a first state which has a spin and can exhibit a DTC phase for a retention time below a second state not exhibiting a DTC phase by more than thermal energy. It may be also preferable that the first state may be above a third state not having spin.

Although the disclosure has been described in detail with reference to its presently preferable embodiments, it will be understood by one of ordinary skill in the art that various modifications can be made without departing from the spirit and the scope of the disclosure, as set forth in the appended claims.

What is claimed is:

1. A system of quantum computation comprising: a room temperature operating quantum computing chip, a readout, a controller, a resistor, and a storage, wherein the room temperature operating quantum computing chip is configured to execute a quantum calculation inside according to a given algorithm for quantum computing, wherein the readout reads a calculation result which is output to an external of the room temperature operating quantum computing chip as an output of the room temperature operating quantum computing chip, wherein the controller is configured to control an input to be input to the room temperature operating quantum computing chip, the output to be output from the room temperature operating quantum computing chip and to be forwarded to the storage through the resistor, wherein the register is configured to convert the output to be suitable to be stored in the storage that stores the output converted by the register.

2. The system of quantum computation as claimed in claim 1, wherein the room temperature quantum computing chip comprises a layer including an array of qubits that comprises plurality of qubits and each of the qubits has a band structure that includes a first state having a spin and the spin is potentially influenced by an external field to be applied to the array of qubits; and the first state hardly exhibits a change for a retention time of discrete time crystalline phase under the external field, wherein an energy difference between the first state and a second state whose energy is higher than that of the first state is larger than a thermal energy if the second state has spin.

3. The system of quantum computation as claimed in claim 2, wherein the layer including an array of qubits is stacked vertically to form a three-dimensional array of qubits that composes the room temperature operating quantum computing chip, wherein an interlayer exists between layers respectively including arrays of qubits.

4. The system of quantum computation as claimed in claim 2, wherein each of the qubits has a shape designed in order to tune a correlation with a neighboring qubit in the array of qubits; and the correlation is stronger via a wider edge which is confronted with the neighboring qubit and through a shorter distance from the neighboring qubit in the array of qubits, wherein the array of qubits has a pattern designed in order to control a configuration of correlations among qubits; and the correlations are controlled by designing the shape of qubits and the pattern of the array of qubits.

5. The system of quantum computation as claimed in claim 3, wherein the interlayer between layers respectively including two arrays of qubits is tuned in thickness to control a vertical correlation between qubits confronted vertically; and areas of qubits and a material property of the interlayer is tuned to control the vertical correlation.

6. The system of quantum computation as claimed in claim 5, wherein the shape and area of qubits and the pattern of the array of qubits are designed to control a retention time of discrete time crystalline phase so that an execution of the quantum calculation is completed within the retention time of discrete time crystalline phase.

7. The system of quantum computation as claimed in claim 6, wherein a plurality of qubits composing a part of the room temperature cooperating quantum computing have a distribution in the retention time of discrete time crystalline phase; and qubits belonging to a lower tail of the distribution is recovered or disposed in the quantum computation by an error correction code.

8. The system of quantum computation as claimed in claim 2, wherein an external field may be generated by an external field generator which is included in a layer to be stacked vertically together with a layer including an array of qubits, wherein the layer including the external field generator has a first connecting hole which locates at a corner not overlapping with the array of qubits; and a second connecting hole, wherein the layer including the array of qubits may have a second connecting hole at the same corner that the first connecting corner locates.

9. The system of quantum computation as claimed in claim 8, wherein the external field generator may generate a magnetic field.

10. The system of quantum computation as claimed in claim 8, wherein the external field generator may generate an electric field.

11. The system of quantum computation as claimed in claim 8, wherein the external field generator may generate an electro-magnetic field.

12. The system of quantum computation as claimed in claim 8, wherein the array of qubits may locate at a corner different from the corner through which the first and second corners go.

13. The system of quantum computation as claimed in claim 8, wherein the array of qubits may locate between other corners.

14. The system of quantum computation as claimed in claim 8, wherein a through silicon via may go through the first and second connecting holes to arrive at a surface of a substrate above which said layers having the first and second connecting holes may be stacked.

15. The system of quantum computation as claimed in claim 14, wherein the surface of substrate may have a connection to a power unit.

16. The system of quantum computation as claimed in claim 14, wherein the surface of substrate may have a controller of external field.

17. The system of quantum computation as claimed in claim 2, wherein plurality of qubits may be fabricated by implantation of atoms, molecules or ions into a substrate forming a layer including the array of qubits through a mask; wherein shape and area of each of the qubits and pattern of array of qubits may be defined by a pattern on the mask.
